(19) United States
(12) Patent Application Publication
(10) Pub. No.: US 2009/0245388 A1
(43) Pub. Date: Oct. 1, 2009

(54) Memory saving method performed in signal processing apparatus and image restoring device using the memory saving method

(75) Inventor: Jung-Hyun Lim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/385,123

(22) Filed: Mar. 31, 2009

(30) Foreign Application Priority Data
Apr. 1, 2008 (KR) 10-2008-0030302

(51) Int. Cl. H04N 7/12

(52) U.S. Cl. 375/240.25; 375/E07.027

(57) ABSTRACT

A memory saving method performed in a signal processing apparatus may include the operations of performing decoding processing on an input video compressed image stream; individually inputting decoding processed data of a previous frame and decoding processed data of a current frame, the decoding processed data of a previous frame and the decoding processed data of a current frame being generated in the decoding processing; and performing response time compensation processing by using the input decoding processed data of the previous frame and the input decoding processed data of the current frame.

This application claims priority under 35 U.S.C. § 119 to Korean Patent Application No. 10-2008-0030302, filed on Apr. 1, 2008, in the Korean Intellectual Property Office (KIPO), the entire contents of which are incorporated herein by reference.

### BACKGROUND

Example embodiments relate to a method and device for processing a video signal, and more particularly, to a method and device for performing decoding processing and response time compensation processing on a digital video signal.

In general, liquid crystal display (LCD) devices used for an image restoring system may be broadly used as a display device not only for personal computers (PCs) but also for high-definition (HD) televisions (TVs). Thus, in order to enable LCD devices to operate well in a multimedia environment, the liquid crystal responding according to an applied image data voltage must have a fast response time.

Accordingly, a response time compensation circuit is added to LCD devices so as to improve the response time of the liquid crystal. However, since the response time compensation circuit may require an image frame memory, the image frame memory may be additionally used and may result in a problem in that material costs increase.

### SUMMARY

Example embodiments provide a memory saving method which may be performed in a signal processing apparatus by designing a frame memory to be jointly used in both a video decoder and a response time compensation circuit.

Example embodiments also provide an image restoring device which may save memory by jointly using a frame memory in both a video decoder and a response time compensation circuit.

An aspect of example embodiments may provide a memory saving method performed in a signal processing apparatus including the operations of performing decoding processing on an input video compressed image stream; individually inputting decoding processed data of a previous frame and decoding processed data of a current frame which are generated in the decoding processing; and performing response time compensation processing by using the input decoding processed data of the previous frame and the input decoding processed data of the current frame.

The operation of performing the response time compensation processing may include the operations of individually transforming the input decoding processed data of the previous frame and the input decoding processed data of the current frame, from a block unit state to a line unit state, and outputting line-unit decoding processed data of the previous frame and line-unit decoding processed data of the current frame; and generating compensated image data by considering a response time of a liquid crystal display (LCD) device, based on a difference between the line-unit decoding processed data of the previous frame and the line-unit decoding processed data of the current frame.

The decoding processed data of the current frame generated in the decoding processing may be stored in a frame memory of a video decoder, and the decoding processed data of the previous frame generated in the decoding processing may be read from the frame memory.

The operation of performing the decoding processing may include the operation of performing motion compensation processing by using the decoding processed data of the previous frame read from the frame memory of the video decoder, according to a motion vector.

The operation of performing the decoding processing may include the operations of extracting a discrete cosine encoding coefficient from the input video compressed image stream, performing inverse variable length encoding, and generating variable decoding processed data and a motion vector; inputting the variable decoding processed data, and performing inverse quantization processing; inputting the inverse quantization processed data, and performing inverse discrete cosine transformation processing; generating motion compensation data from the decoding processed data of the previous frame by using the motion vector; and adding the motion compensation data to the inverse discrete cosine transformation processed data so as to generate the decoding processed data of the current frame.

The operation of performing the decoding processing may further include the operation of storing the decoding processed data of the current frame in the frame memory of the video decoder, wherein the decoding processed data of the previous frame may be read from the frame memory.

The memory saving method may further include the operation of displaying the response time compensation processed image data on an LCD device.

Example embodiments provide an image restoring device which may include a video decoder which may perform decoding processing on a video compressed image stream; a first transformer which may input decoding processed image data of a current frame generated in the video decoder, transform the decoding processed image data into line-unit data, and output line-unit decoding processed image data; a second transformer which may input decoding processed image data of a previous frame generated in the video decoder, transform the decoding processed image data into line-unit data, and output line-unit decoding processed image data; and a response time compensation circuit which may generate compensated image data by considering a response time of an LCD device, based on a difference between the line-unit decoding processed image data of the current frame output from the first transformer and the line-unit decoding processed image data of the previous frame output from the second transformer.

The decoding processed image data of the current frame generated in the video decoder and the decoding processed image data of the previous frame generated in the video decoder may be individually processed in units of blocks.

The video decoder may include a frame memory, may store the decoding processed image data of the current frame in the frame memory, and may read the decoding processed image data of the current frame stored in the frame memory after a delay of as much as one frame, thereby generating the decoding processed image data of the previous frame.

The video decoder may perform motion compensation processing by using the decoding processed image data of the previous frame read from the frame memory, according to a motion vector.

The video decoder may include a variable length decoder which may extract a discrete cosine encoding coefficient from the video compressed image stream, perform inverse variable length encoding, and generate variable length decoding processed data and a motion vector; an inverse quantizer which may input the variable length decoding processed data, and perform inverse quantization processing; an IDCT (inverse discrete cosine transformer) which may input the inverse quantization processed data, and perform inverse discrete cosine transformation processing; a motion compensator which may input decoding processed data of a previous frame, and generate motion compensation data by using the motion vector; an adder which may add the motion compensation data to the inverse discrete cosine transformation processed data so as to generate decoding processed data of a current frame; and the frame memory which may store the decoding processed data of the current frame generated in the adder, and read and output the decoding processed data of the previous frame which may be delayed by as much as one frame.

The response time compensation circuit may generate compensated frame data having a gray scale voltage greater or lesser than current frame data, by using a look-up table, based on the difference between the line-unit decoding processed image data of the current frame output from the first transformer and the line-unit decoding processed image data of the previous frame output from the second transformer.

Components forming the image restoring device may be designed so as to form a single integrated circuit.

Example embodiments provide an image restoring device which may comprise a video decoder which may be configured to generate and output decoding processed image data of a current frame by performing decoding processing on a video compressed image stream using decoding processed image data of a previous frame; a response time compensation circuit which may be configured to generate compensated image data based on a difference between the decoding processed image data of the current frame output by the video decoder and the decoding processed image data of the previous frame; and a frame memory which may be shared by the video decoder and the response time compensation circuit, and may be configured to store the decoding processed image data of a previous frame and to provide the decoding processed image data of a previous frame to both the video decoder and the response time compensation circuit.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of an image restoring system according to example embodiments;

FIG. 2 is a block diagram of a detailed circuit configuration of a video decoder illustrated in FIG. 1;

FIG. 3 is a block diagram of a response time compensation device according to example embodiments;

FIG. 4 is a block diagram of an image restoring device according to example embodiments; and

FIG. 5 is a flowchart of signal processing by using a memory saving method performed in a signal processing apparatus, according to an embodiment of example embodiments.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

First, an image restoring system according to example embodiments will now be described.

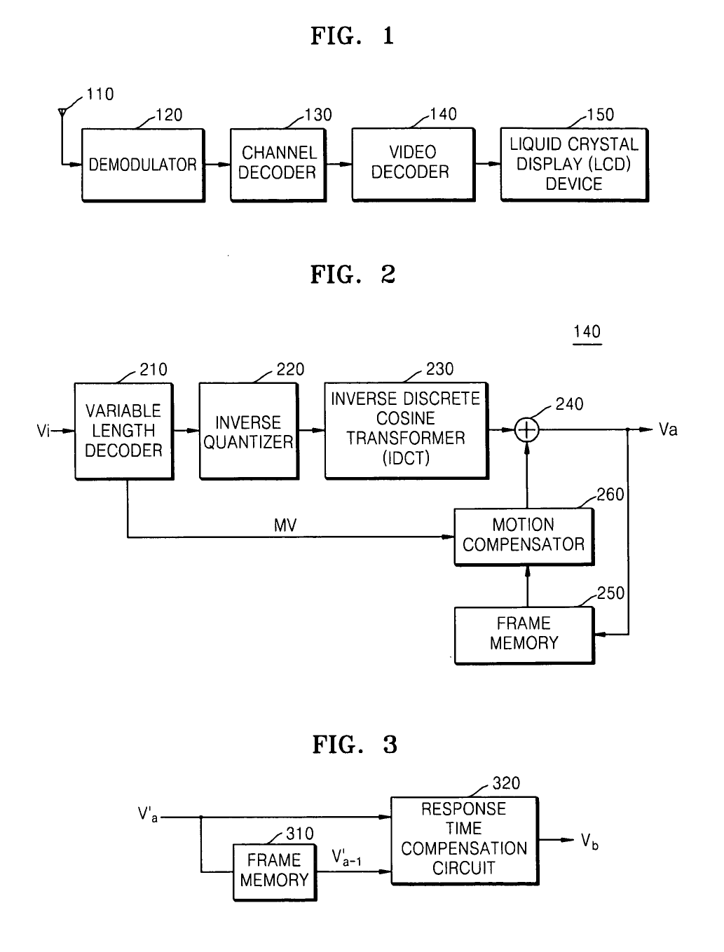

As illustrated in FIG. 1, an image restoring system according to example embodiments may include an antenna 110, a demodulator 120, a channel decoder 130, a video decoder 140, and a liquid crystal display (LCD) device 150.

Operations performed in the image restoring system of FIG. 1 will now be described.

According to example embodiments, a modulated broadcasting signal may be received via the antenna 110, demodulated by the demodulator 120, and transformed into a baseband digital signal. After that, the channel decoder 130 may input the demodulated digital broadcasting signal, and perform decoding processing to correct an error occurred in a transmission channel. Next, the video decoder 140 may input a compressed image signal which may be channel decoding processed, and may perform decoding processing to output a restored image signal to the LCD device 150.

The LCD device 150 may perform response time compensation processing on the input restored image signal, and may display an image by using a liquid crystal device.

FIG. 2 is a block diagram of a detailed circuit configuration of the video decoder 140.

As illustrated in FIG. 2, the video decoder 140 may include a variable length decoder 210, an inverse quantizer 220, an inverse discrete cosine transformer (IDCT) 230, an adder 240, a frame memory 250, and a motion compensator 260.

The variable length decoder 210 may input a video compressed stream Vi, and may decode a motion vector MV and coded error coefficient data in units of macroblocks. Here, the motion vector MV may indicate a position change of a macroblock in video data with respect to an image reconstructed from a reference image. Also, the error coefficient data may indicate a difference between each of adjacent video image data values.

A block of the error coefficient data decoded by the variable length decoder 210 may be inverse quantized by the inverse quantizer 220 using a quantization table, and then inverse discrete cosine transformed by the IDCT 230.

The motion compensator 260 may patch a reference macroblock of a previous frame from the frame memory 250, and may generate motion compensation data by using the MV.

The adder 240 may add the motion compensation data to the inverse discrete cosine transformed data so as to generate decoding processed data Va of a current frame. The decoding processed data Va of the current frame may be stored in the frame memory 250 so as to be used in decoding processing of a next frame.

For reference, in Moving Picture Experts Group (MPEG), a first example of a decoded picture type is an I picture (or I-frame) which has been encoded by only using data of the current frame, thus, the MPEG may outputs inverse discrete cosine transformed data as restored data, without motion compensation. After decoding of the I picture, the motion compensation may be performed on a P picture (or P-frame) and a B picture (or B-frame) by referring to a plurality of pieces of decoded data of a previous frame stored in the frame memory 250 so that the P picture and the B picture are restored.

The frame memory 250 may be required to perform video decoding processing in this manner.

In order to complement a relatively low response time of the liquid crystal device used in the LCD device 150 of FIG. 1, a response time compensation device may be used.

FIG. 3 is a block diagram of a response time compensation device related to example embodiments.

As illustrated in FIG. 3, the response time compensation device may include a frame memory 310 and a response time compensation circuit 320.

The response time compensation device may store restored data V′a of a current frame in the frame memory 310, and read data V′a-1 of a previous frame, which may be delayed by as much as one frame, from the frame memory 310 so as to output the data V′a-1 to the response time compensation circuit 320.

In general, a dynamic capacitance compensation (DCC) circuit may be used as the response time compensation circuit 320. The DCC circuit may compare the restored data V′a of the current frame to the data V′a-1 of the previous frame, and, according to a result of the comparison, may output image frame data Vb, which may have a gray scale voltage greater or lesser than current image frame data, by using a look-up table so as to improve a response time of liquid crystal.

As described above, the response time compensation device may require the frame memory 310.

Referring to FIGS. 2 and 3, it is possible to understand that the video decoder and the response time compensation device may individually use a frame memory.

According to example embodiments, the response time compensation processing may be performed by using the frame memory used in the video decoder without adding a separate frame memory to the response time compensation device. Example embodiments present a technology by which both the video decoder and the response time compensation device may jointly use one frame memory.

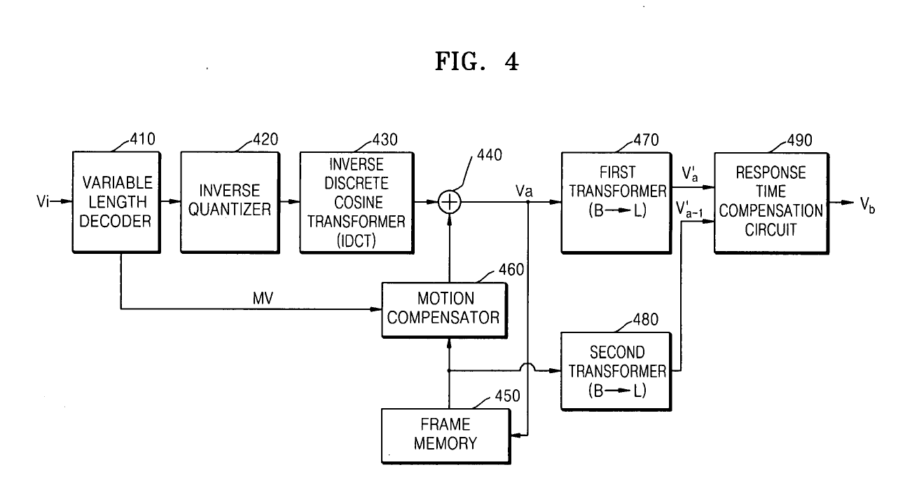

FIG. 4 is a block diagram of an image restoring device according to example embodiments.

As illustrated in FIG. 4, the image restoring device according to example embodiments may include a variable length decoder 410, an inverse quantizer 420, an IDCT 430, an adder 440, a frame memory 450, a motion compensator 460, first and second transformers 470 and 480, and a response time compensation circuit 490.

The variable length decoder 410, the inverse quantizer 420, the IDCT 430, the adder 440, the frame memory 450, and the motion compensator 460, which may form a video decoder, may perform in a manner substantially similar to that described with respect to the variable length decoder 210, the inverse quantizer 220, the IDCT 230, the adder 240, the frame memory 250, and the motion compensator 260 which are illustrated in FIG. 2. Thus, descriptions thereof will be omitted here.

Since the video decoder may process and restore data in units of macroblocks, decoding processed data Va of a current frame output from the adder 440 may correspond to data in the units of macroblocks. Also, decoding processed data of a previous frame, which is read from the frame memory 450 and output to the motion compensator 460, may correspond to data in the units of macroblocks.

However, data processed in the response time compensation circuit 490 may be data in a unit of a line. Thus, the data processed in the video decoder may not be directly input to the response time compensation circuit 490 and used.

In order to solve this problem, the first and second transformers 470 and 480 may transform block-unit decoding processed data, which is generated in the video decoder, into line-unit data, and output the line-unit data to the response time compensation circuit 490.

According to example embodiment, the first transformer 470 may input and transform the decoding processed data Va, which is block-unit data of the current frame output from the adder 440 of the video decoder, into decoded data V′a in units of lines, and may thereby output the decoded data V′a.

The second transformer 480 may input and transform the decoding processed data, which is block-unit data of the previous frame read from the frame memory 450 of the video decoder, into decoded data V′a-1 in units of lines, and may thereby output the decoded data V′a-1.

The response time compensation circuit 490 may input the decoded data V′a of the current frame and the decoded data V′a-1 of the previous frame, which are respectively transformed and output by the first transformer 470 and the second transformer 480, and may output image frame data Vb having a gray scale voltage greater or lesser than the decoded data V′a of the current frame, based on a difference between the decoded data V′a of the current frame and the decoded data V′a-1 of the previous frame. By doing so, the response time compensation circuit 490 may improve the response time of liquid crystal.

In this manner, the response time compensation device may not use a separate frame memory but may use the decoded data of the previous frame and the decoded data of the current frame, which are generated in the video decoder, so as to perform the response time compensation processing. According to example embodiments, both the video decoder and the response time compensation device may jointly use one frame memory so as to perform video decoding processing and the response time compensation processing.

According to example embodiments, a circuit of the image restoring device, which includes the video decoder and the response time compensation circuit 490 illustrated in FIG. 4, may be designed as a single chip. In this case, data transmission speed in relation to an LCD device, which may be high, conventionally, may be decreased so that a cable with low speed may be used instead of using a high speed low voltage differential signals (LVDS) cable.

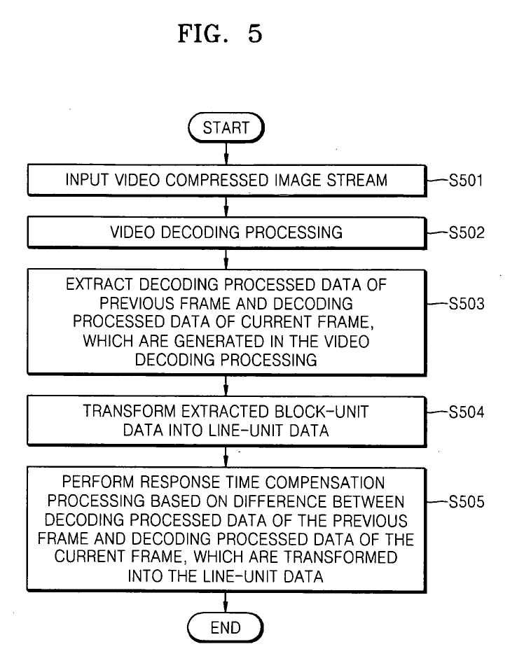

FIG. 5 is a flowchart of signal processing by using a memory saving method performed in a signal processing apparatus, according to example embodiments.

First, a video compressed image stream may be input to an image restoring device (operation S501). An example of the video compressed image stream may be a channel decoding processed signal obtained by demodulating a digital broadcasting signal received via an antenna.

Next, decoding processing may be performed on the video compressed image stream (operation S502). A video decoding processing procedure may be performed in such a manner that variable length decoding processing, inverse quantization, and inverse discrete cosine transformation are sequentially performed on the video compressed image stream, and inverse discrete cosine transformed data is added to motion compensation data generated from data of a decoding processed reference macroblock of a previous frame, so as to generate decoding processed data of a current frame.

Next, the decoding processed data of the previous frame and the decoding processed data of the current frame, which may be generated in the video decoding processing procedure, may be extracted (operation S503).

Block-unit data extracted in operation S503 may be transformed into line-unit data (operation S504). According to example embodiments, the decoding processed data of the previous frame and the decoding processed data of the current frame, which may be generated in the video decoding processing procedure, may be data in units of macroblocks. Thus, in order to perform response time compensation processing, the data may be required to be transformed into line-unit data. For example, the transformation may be performed by storing block-unit data in a buffer, and then reading the block-unit data stored in the buffer according to a line-unit.

A difference between decoding processed data of the previous frame and decoding processed data of the current frame, which are transformed into the line-unit data in operation S504, may be obtained, and the response time compensation processing may be performed by using a look-up table, based on the obtained difference (operation S505).

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A memory saving method performed in a signal processing apparatus, the memory saving method comprising:
performing decoding processing on an input video compressed image stream;
individually inputting decoding processed data of a previous frame and decoding processed data of a current frame, the decoding processed data of a previous frame and decoding processed data of a current frame being generated in the decoding processing; and
performing response time compensation processing by using the input decoding processed data of the previous frame and the input decoding processed data of the current frame.

2. The memory saving method of claim 1, wherein the performing of the response time compensation processing includes
individually transforming the input decoding processed data of the previous frame and the input decoding processed data of the current frame from a block unit state to a line unit state, and outputting line-unit decoding processed data of the previous frame and line-unit decoding processed data of the current frame; and
generating compensated image data by considering a response time of an LCD (liquid crystal display) device, based on a difference between the line-unit decoding processed data of the previous frame and the line-unit decoding processed data of the current frame.

3. The memory saving method of claim 1, wherein the decoding processed data of the current frame generated in the decoding processing is stored in a frame memory of a video decoder, and the decoding processed data of the previous frame generated in the decoding processing is read from the frame memory.

4. The memory saving method of claim 1, wherein the performing of the decoding processing includes performing motion compensation processing by using the decoding processed data of the previous frame read from the frame memory of the video decoder, according to a motion vector.

5. The memory saving method of claim 1, wherein the performing of the decoding processing includes
extracting a discrete cosine encoding coefficient from the input video compressed image stream, performing inverse variable length encoding, and generating variable decoding processed data and a motion vector;
inputting the variable decoding processed data, and performing inverse quantization processing;
inputting the inverse quantization processed data, and performing inverse discrete cosine transformation processing;
generating motion compensation data from the decoding processed data of the previous frame by using the motion vector; and
adding the motion compensation data to the inverse discrete cosine transformation processed data so as to generate the decoding processed data of the current frame.

6. The memory saving method of claim 5, wherein the performing of the decoding processing further includes storing the decoding processed data of the current frame in the frame memory of the video decoder, and the decoding processed data of the previous frame is read from the frame memory.

7. The memory saving method of claim 1, further comprising displaying the response time compensation processed image data on an LCD device.

8. An image restoring device, comprising:
a video decoder configured to perform decoding processing on a video compressed image stream;
a first transformer configured to input decoding processed image data of a current frame generated in the video decoder, transform the decoding processed image data into line-unit data, and output line-unit decoding processed image data;
a second transformer configured to input decoding processed image data of a previous frame generated in the video decoder, transform the decoding processed image data into line-unit data, and output line-unit decoding processed image data; and
a response time compensation circuit configured to generate compensated image data based on a difference between the line-unit decoding processed image data of the current frame output from the first transformer and the line-unit decoding processed image data of the previous frame output from the second transformer.

9. The image restoring device of claim 8, wherein the decoding processed image data of the current frame generated in the video decoder and the decoding processed image data of the previous frame generated in the video decoder are individually processed in units of blocks.

10. The image restoring device of claim 8, wherein the video decoder includes a frame memory, and the video decoder is configured to store the decoding processed image data of the current frame in the frame memory, and read the decoding processed image data of the current frame stored in the frame memory after a delay of as much as one frame, thereby generating the decoding processed image data of the previous frame.

11. The image restoring device of claim 10, wherein the video decoder is configured to perform motion compensation processing by using the decoding processed image data of the previous frame read from the frame memory, according to a motion vector.

12. The image restoring device of claim 8, wherein the video decoder includes
a variable length decoder configured to extract a discrete cosine encoding coefficient from the video compressed image stream, perform inverse variable length encoding, and generate variable length decoding processed data and a motion vector;
an inverse quantizer configured to input the variable length decoding processed data, and perform inverse quantization processing;
an IDCT (inverse discrete cosine transformer) configured to input the inverse quantization processed data, and perform inverse discrete cosine transformation processing;
a motion compensator configured to input decoding processed data of a previous frame, and generate motion compensation data by using the motion vector;
an adder configured to add the motion compensation data to the inverse discrete cosine transformation processed data so as to generate decoding processed data of a current frame; and
a frame memory configured to store the decoding processed data of the current frame generated in the adder, and to read and output the decoding processed data of the previous frame, the decoding processed data of the previous frame being delayed by as much as one frame.

13. The image restoring device of claim 8, wherein the response time compensation circuit is configured to generate compensated frame data having a gray scale voltage greater or lesser than current frame data by using a look-up table, based on the difference between the line-unit decoding processed image data of the current frame output from the first transformer and the line-unit decoding processed image data of the previous frame output from the second transformer.

14. The image restoring device of claim 8, wherein components forming the image restoring device are designed so as to form a single integrated circuit.

15. An image restoring device, comprising:
a video decoder configured to generate and output decoding processed image data of a current frame by performing decoding processing on a video compressed image stream using decoding processed image data of a previous frame;
a response time compensation circuit configured to generate compensated image data based on a difference between the decoding processed image data of the current frame output by the video decoder and the decoding processed image data of the previous frame; and
a frame memory, the frame memory being shared by the video decoder and the response time compensation circuit, the frame memory being configured to store the decoding processed image data of a previous frame and to provide the decoding processed image data of a previous frame to both the video decoder and the response time compensation circuit.
